(19) United States
(12) Patent Application Publication
(10) Pub. No.: US 2004/0035637 A1
(43) Pub. Date: Feb. 26, 2004

(54) Sectional modified step housing ladder with removable rungs

(76) Inventor: Timothy Scott Skipper, Ormond Beach, FL (US)

Correspondence Address: Pennington, Moore, Wilkinson, Bell & Dunbar, P.A., Post Office Box 10095, Tallahassee, FL, 32301-2095, US

(21) Appl. No.: 10/651,117

(22) Filed: Aug. 28, 2003

Related U.S. Application Data
(63) Continuation-in-part of application No. 10/058,901, filed on Jan. 30, 2002, now Pat. No. 6,668,975.
(60) Provisional application No. 60/406,537, filed on Aug. 28, 2002.

(51) Int. Cl. E06C 9/00

(52) U.S. Cl. 182/92; 182/100

(57) ABSTRACT

A ladder is composed of a vertical support structure and a set of rungs. In the present invention, the vertical support structure is formed by a sailboat mast or other vertical object to be climbed. A set of step housings are attached to the mast. Each step housing contains an inclined hole sized to receive a removable rung. A set of removable rungs are provided. Each such rung has an insertion cylinder and a step. The insertion cylinder is placed in the inclined hole on one of the step housings. Interlocking mechanical features lock the removable rung in the step housing. The user can thus install a number of removable rungs in order to easily climb the sailboat mast or other vertical object.

### CROSS-REFERENCES TO RELATED APPLICATIONS

This application is a non-provisional application claiming the benefit, pursuant to 37 C.F.R §1.53 (c), of an earlier filed provisional application. The provisional application listed the same inventor. It was filed on Aug. 28, 2002 and assigned serial No. 60/406,537, continuation in part of application Ser. No. 10/058,901, having a filing date of Jan. 30, 2002.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of ladders. More specifically, the invention comprises a removable ladder rung and a housing for attaching the rung to an object to be climbed.

2. Description of the Related Art

The incorporation of removable rungs into various structures is well known in the prior art. As one example, U.S. Pat. No. 6,247,553 to Jones (2001) discloses a removable rung (or step) designed to be applied to a steel T-post of the type commonly used for cattle fencing. It allows a user to step over a modern fence line without having to put weight on the strands of barbed wire. The Jones device is not easily removable, however. It is designed to be installed and left in place. Thus, it is ill suited for the type of application encompassed by the present invention.

U.S. Pat. No. 3,833,090 to Georgianna (1974) discloses a removable step designed to be locked into a steel support column. This invention is directed to warehouse racks, whose vertical columns already include slots for the mounting of shelves and the like. The step design in the '090 patent takes advantage of these preexisting slots. The step is quite large and cumbersome, however. It would be difficult to store a set of such steps on the user's person, and quite cumbersome to carry them over long distances.

A similar device is disclosed in U.S. Pat. No. 4,450,936 to Strom (1984). The Strom device also takes advantage of the pre-existing slots found in warehouse columns. Unlike the Georgianna device, though, it is formed of simple bar stock components. The '936 device should therefore be easier to fabricate. It is still quite bulky, however. In addition, it requires a support column having a large interior cavity so that the step can be “snaked” into position. While such a large cavity is often found in warehouse columns, it is rarely found elsewhere.

### BRIEF SUMMARY OF THE INVENTION

A ladder is composed of a vertical support structure and a set of rungs. In the present invention, the vertical support structure is formed by a sailboat mast or other vertical object to be climbed. A set of step housings are attached to the mast. Each step housing contains an inclined hole sized to receive a removable rung. A set of removable rungs are provided. Each such rung has an insertion cylinder and a step. The insertion cylinder is placed in the inclined hole on one of the step housings. Interlocking mechanical features lock the removable rung in the step housing. The user can thus install a number of removable rungs in order to easily climb the sailboat mast or other vertical object.

### BRIEF DESCRIPTION OF THE SEVERAL VIEWS OF THE DRAWINGS

FIG. 1 is a hidden line view, showing the step housing.

FIG. 2 is a hidden line view, showing the step housing.

FIG. 3 is a hidden line view, showing the step housing in the orientation in which it is typically installed.

FIG. 4 is an isometric view, showing a step housing installed on a mast.

FIG. 5 is anisometric view, showing a variety of removable rungs.

FIG. 6 is an isometric view, showing a set of step housings installed on a mast.

FIG. 7 is a hidden line view, showing the use of step housings having alternating inclined holes.

FIG. 8 is an isometric view, showing a set of step housings installed on a mast.

FIG. 9 is a hidden line view, showing the installation of a removable rung in a step housing.

FIG. 10 is a hidden line view, showing the installation of a removable rung in a step housing.

FIG. 11 is a hidden line view, showing a set of removable rungs installed in a set of step housings.

FIG. 12 is a hidden line view, showing an alternate version of the step housing.

### REFERENCE NUMERALS IN THE DRAWINGS

10 inclined hole

12 mounting hole

13 trailing protrusion

14 leading protrusion

15 step housing

16 mast

18 admission slot

20 insertion cylinder

22 step

24 removable rung

26 fastener

28 straight step

30 dropped step

32 angled dropped step

34 deck

### DETAILED DESCRIPTION OF THE INVENTION

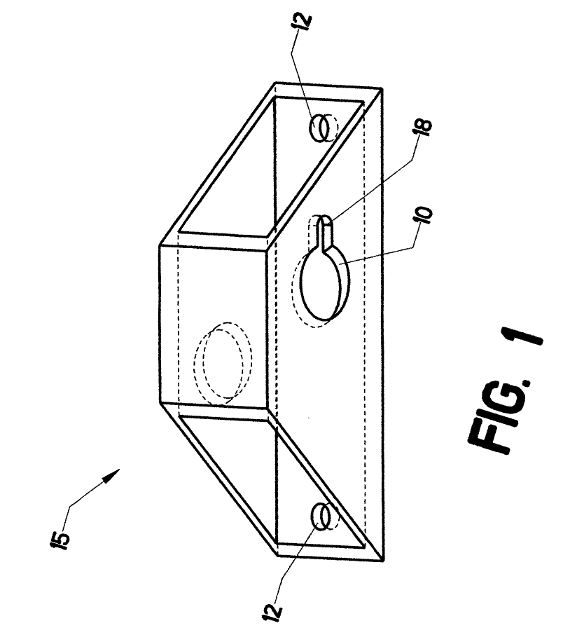

FIG. 1 shows step housing 15. It has a first side wall facing the viewer and a second side wall on the opposite side. These two side walls are pierced by inclined hole 10. Abase plate joins the two side walls. It contains the means for mounting the device—two mounting holes 12. An additional wall is preferably present joining the first and second side walls in order to strengthen the device. This additional wall is facing to the left in the view as shown. Admission slot 18 passes through the first side wall and is joined to the intersection of inclined hole 10 with that first side wall. The purpose for admission slot 18 will be explained shortly.

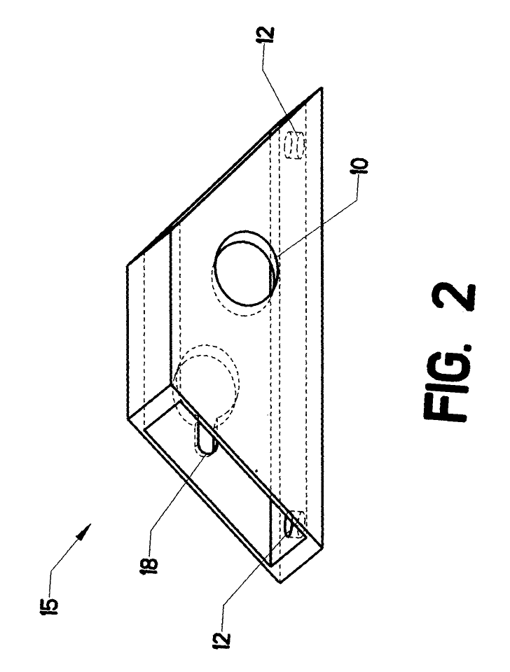

FIG. 2 shows step housing 15 from the opposite side. The reader will observe that the intersection of inclined hole 10 with the second side wall does not include an admission slot 18.

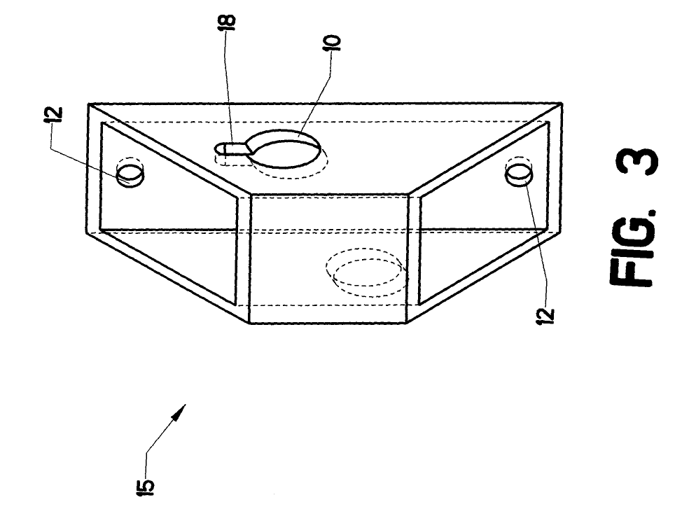

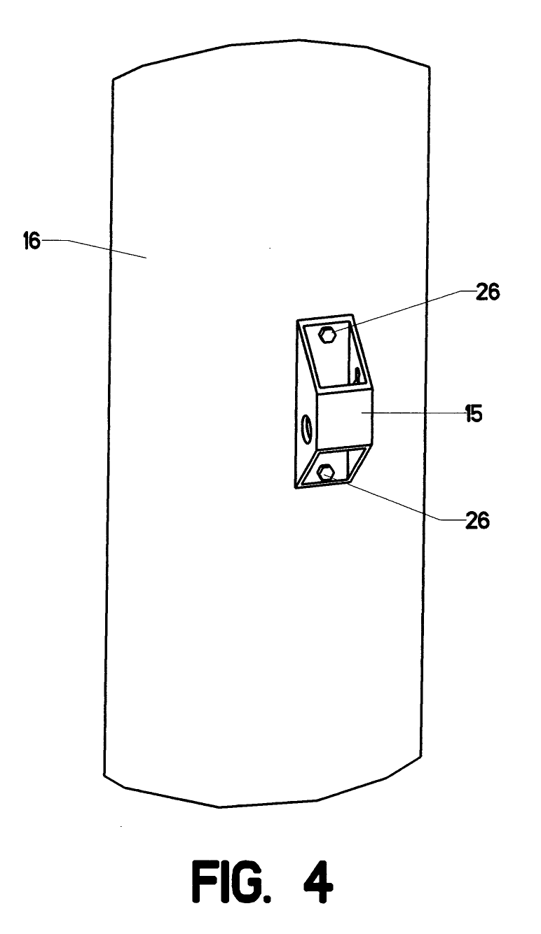

FIG. 3 shows step housing 15 in its customarily installed orientation. The two side walls are oriented vertically. The two mounting holes 12 are positioned to allow the use of bolts or similar fasteners in the attachment of the device. FIG. 4 shows step housing 15 attached to mast 16. Two fasteners 26 (in this case bolts) have been passed through the two mounting holes 12 and into mast 16. Mast 16 is a circular vertical object such as is commonly found on sailboats. However, the invention is not confined to the field of boating. It can be applied to telephone pole and virtually any other type of object to be climbed. A sailboat mast has simply been used as an example.

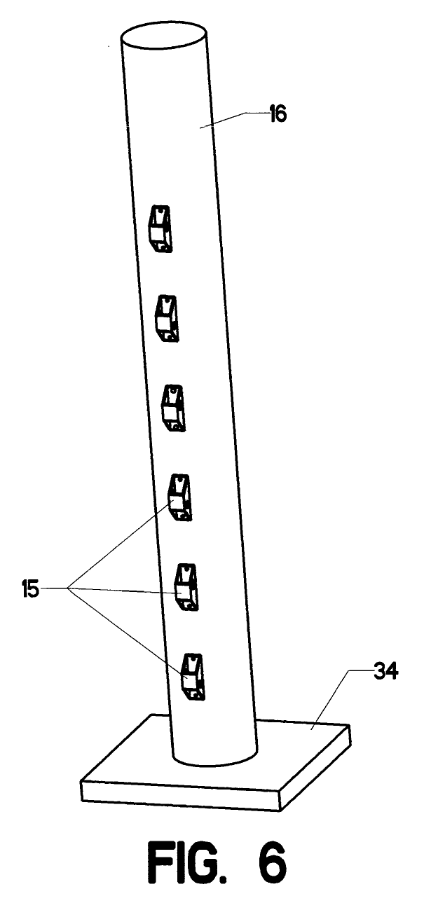

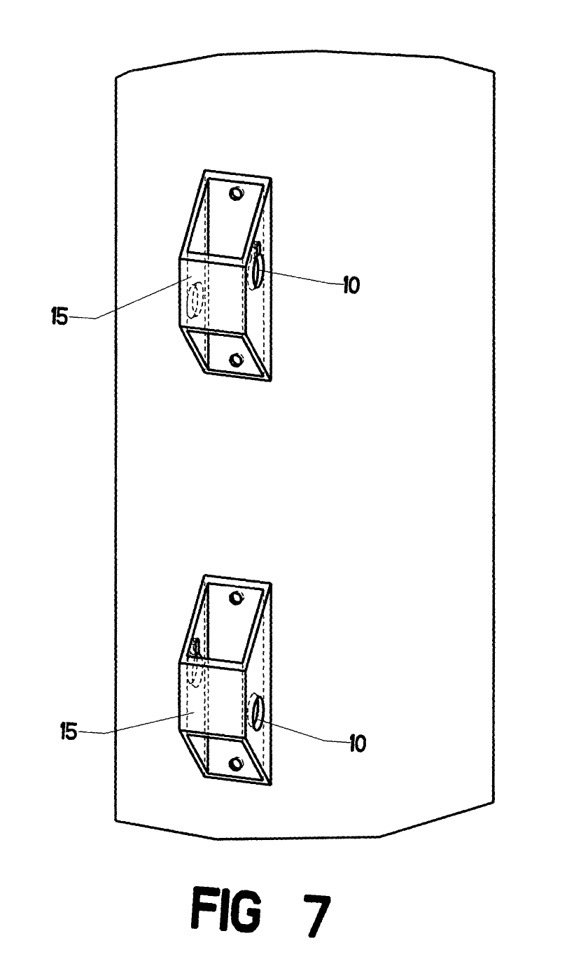

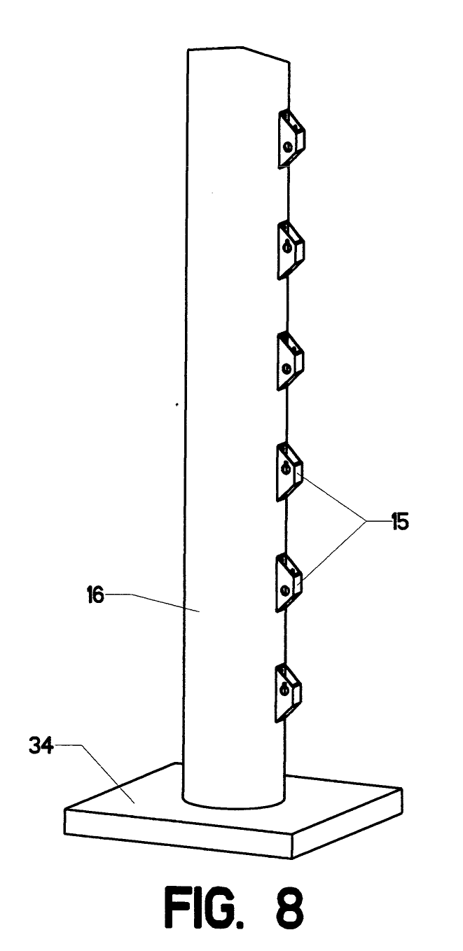

FIG. 6 shows a set of step housings 15 installed up one side of mast 16 (preferably the front side). They are positioned to allow a user to stand on deck 34 and begin climbing the mast. FIG. 7 shows a closer view of two successive step housings 15. The reader will observe that the inclined hole 10 in the upper step housing slopes opposite from the one in the lower step housing 15. This feature allows the removable rungs to be installed in alternating sides, as will be explained subsequently. FIG. 8 shows mast 16 with its installed set of step housings 15.

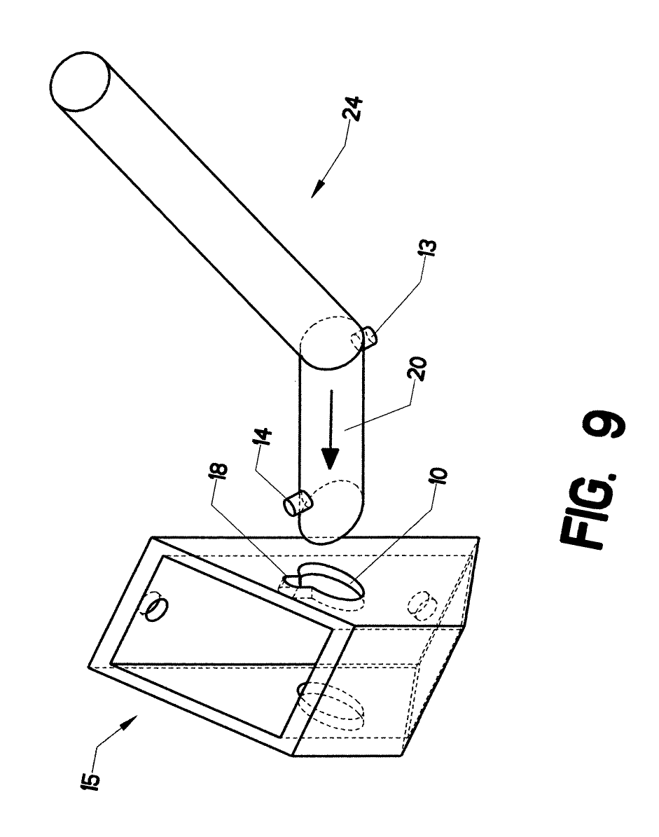

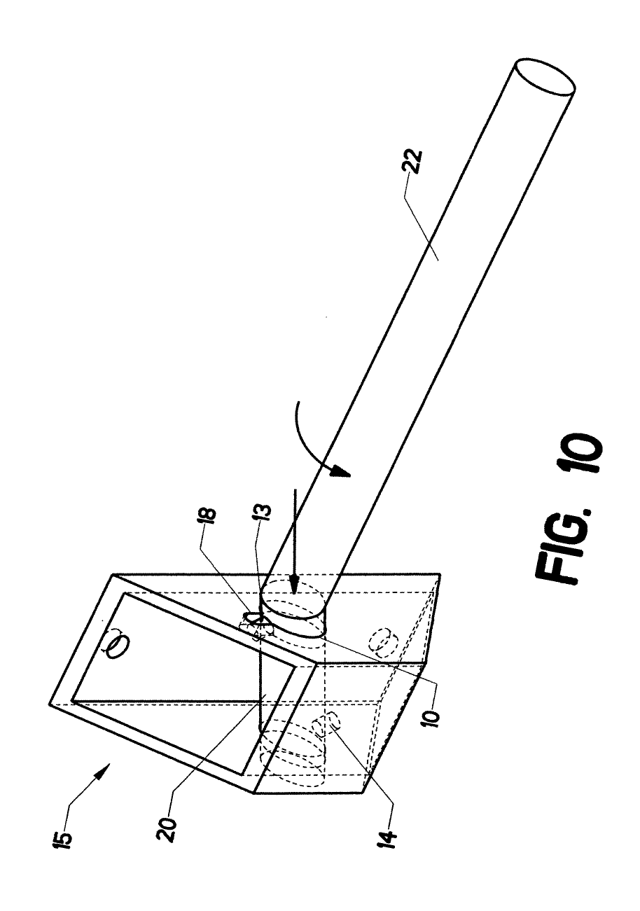

FIGS. 9 and 10 illustrate the installation of a typical removable rung within the step housing. This process is described in co-pending U.S. application Ser. No. 10/162,022, which has been published. The disclosure of U.S. application Ser. No. 10/162,022 is hereby incorporated by reference.

In FIG. 9, removable rung 24 is positioned so that its insertion cylinder 20 is aligned with inclined hole 10. Leading protrusion 14 is likewise aligned with admission slot 18. The user then pushes insertion cylinder 20 into inclined hole 10, as indicated by the arrow. Insertion cylinder 20 will then extend through both the first and second side walls, with leading protrusion 14 resting between the first and second side walls.

Looking now at FIG. 10, the user must next rotate removable rung 24 through 180 degrees (rotating about the insertion cylinder lying within the inclined hole), until trailing protrusion 13 aligns with admission slot 18. The user then advances the insertion cylinder further into the inclined hole until leading protrusion 14 comes to rest against the inside of the second side wall. At this point trailing protrusion 13 is locked within admission slot 18, thereby preventing any unwanted rotation of the removable rung.

The reader will observe that step 22 is at this point horizontal. Those skilled in the art will realize that the interface between the rung and the step housing is very stable, especially when a load is placed on step 22. The removable rung will not come loose unless the user steps off the rung and reverses the process described in FIGS. 9 and 10.

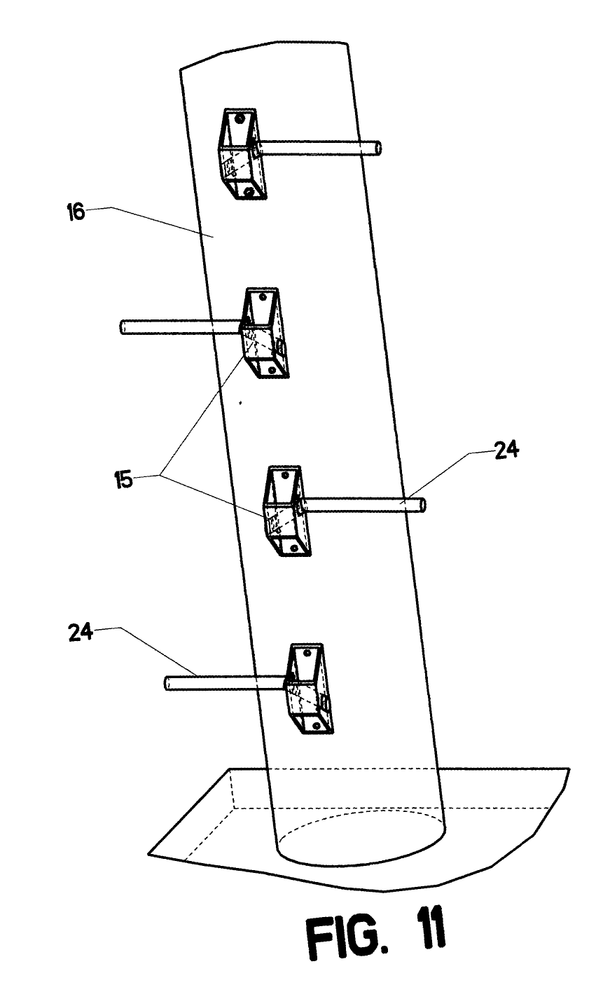

FIG. 11 shows a set of removable rungs 24 installed in a set of step housings 15 on mast 16. As explained previously, two types of step housings are used. One type has the inclined hole sloping downward from right to left, while the other has the inclined holes sloping downward from left to right. This fact allows the insertion of the removable rungs on alternating sides in order to form a convenient climbing pattern.

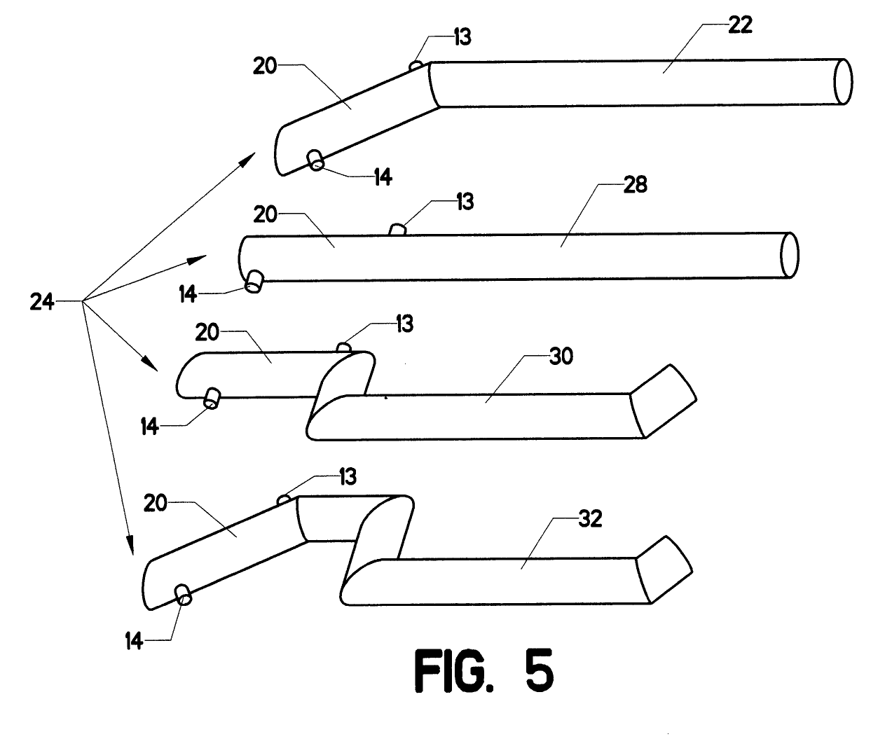

The shape of the removable rung shown in FIGS. 9 and 10 is but one of many possibilities. Those skilled in the art will realize that the key features of the removable rung are the insertion cylinder and two protrusions. The shape of the stepping surface can be varied. FIG. 5 shows such variations. The upper removable rung 24 is the one described previously. The next lower rung is a straight configuration, which can be used with an inclined hole or a non-inclined hole. It has straight step 28.

The next lower rung has dropped step 30. Dropped step 30 runs parallel to the insertion cylinder. When installed, it runs outward and upward from the mast (since the insertion cylinder lies in an inclined hole). If this is not desired, the user can employ the lowest rung shown. It has angled dropped step 32, which will lie perpendicular to the mast once the rung is installed.

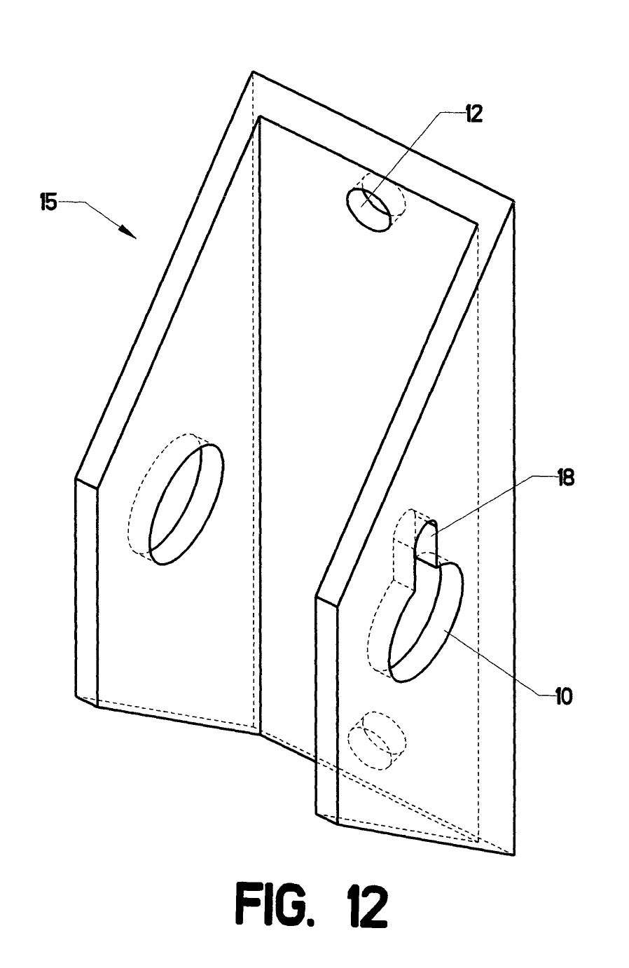

The step housing can assume many forms, and need not be a square cross section. FIG. 12 shows an alternate version made from “C-channel.” The embodiment shown is configured for use with straight step 28. Inclined hole 10 is oriented so that straight step 28 will be horizontal when inserted. For such a scenario, the inclination of the “inclined hole” is, of course, zero. The same name (“inclined hole”) is used so that the reader will understand that it is the same element as shown in the other figures.

Although the preceding description contains significant detail, it should not be construed as limiting the scope of the invention but rather as providing illustrations of the preferred embodiment of the invention. Thus, the scope of the invention should be fixed by the following claims, rather than by the examples given.

Having described my invention, I claim:

1. An assembly for attaching a removable rung to a vertical object to be climbed, comprising:
a. a step housing having a first side wall, a second side wall, and a hole passing completely through said first side wall and said second side wall;
b. attachment means for attaching said step housing to said vertical object to be climbed;
c. wherein said removable rung includes an insertion cylinder sized to slidably fit within said hole, a step, and a leading protrusion extending outward from said insertion cylinder distal from said step; and
d. wherein said first side wall of said step housing opens into an admission slot proximate said hole, sized to allow said leading protrusion to slide therethrough, so that said removable rung can be inserted into said step housing by placing said insertion cylinder within said hole, sliding said leading protrusion through said admission slot, and advancing said insertion cylinder into said hole so that said leading protrusion eventually rests between said first side wall and said second side wall.

2. An assembly as recited in claim 1, wherein said hole has an intersection with said first side wall and an intersection with said second side wall, and wherein said intersection with said first side wall is higher than said intersection with said second side wall so that said hole is inclined from the horizontal.

3. An assembly as recited in claim 1, further comprising:
a. wherein said leading protrusion extends from said insertion cylinder in a position distal from said step;
b. a trailing protrusion, extending from said insertion cylinder in a position proximate said step; and
c. wherein said trailing protrusion is angularly offset from said leading protrusion, so that said removable rung can be inserted into said step housing by placing said insertion cylinder within said hole, sliding said leading protrusion completely through said admission slot, rotating said insertion cylinder in order to align said trailing protrusion with said admission slot, and advancing said insertion cylinder into said hole so that said trailing protrusion rests within said admission slot.

4. An assembly as recited in claim 2, further comprising:
a. wherein said leading protrusion extends from said insertion cylinder in a position distal from said step;
b. a trailing protrusion, extending from said insertion cylinder in a position proximate said step; and
c. wherein said trailing protrusion is angularly offset from said leading protrusion, so that said removable rung can be inserted into said step housing by placing said insertion cylinder within said hole, sliding said leading protrusion completely through said admission slot, rotating said insertion cylinder in order to align said trailing protrusion with said admission slot, and advancing said insertion cylinder into said hole so that said trailing protrusion rests within said admission slot.
